(19) United States
(12) Patent Application Publication
(10) Pub. No.: US 2004/0117186 A1
(43) Pub. Date: Jun. 17, 2004

(54) Multi-channel transcription-based speaker separation

(76) Inventors: Bhiksha Ramakrishnan, Watertown, MA (US); Manuel J. Reyes Gomez, New York, NY (US)

Correspondence Address: Patent Department, Mitsubishi Electric Research Laboratories, Inc., 201 Broadway, Cambridge, MA, 02139, US

(21) Appl. No.: 10/318,714

(22) Filed: Dec. 13, 2002

(51) Int. Cl. G10L 15/28

(52) U.S. Cl. 704/255

(57) ABSTRACT

A method separates acoustic signals generated by multiple acoustic sources, such as mixed speech spoken simultaneously by several speakers in the same room. For each source, the acoustic signals are combined into a mixed signal acquired by multiple microphones, at least one for each source. The mixed signal is filtered, and the filtered signals are summed into a signal from which features are extracted. A target sequence through a factorial HMM is estimated, and filter parameters are optimized accordingly. These steps are repeated until the filter parameters converge to optimal filtering parameters, which are then used to filter the mixed signal once more, and the summed output of this last filtering is the acoustic signal for a particular acoustic source.

### FIELD OF THE INVENTION

The present invention relates generally separating mixed acoustic signals, and more particularly to separating mixed acoustic signals acquired by multiple channels from multiple acoustic sources, such as speakers.

### BACKGROUND OF THE INVENTION

Often, multiple speech signals are generated simultaneously by speakers so that the speech signals mix with each other in a recording. Then, it becomes necessary to separate the speech signals. In other words, when two or more people speak simultaneously, it is desired to separate the speech from the individual speakers from recordings of the simultaneous speech. This is referred to as a speaker separation problem.

In one method, the simultaneous speech is received via a single channel recording, and the mixed signal is separated by time-varying filters, see Roweis, “One Microphone Source Separation,” Proc. Conference on Advances in Neural Information Processing Systems, pp. 793-799, 2000, and Hershey et al., “Audio Visual Sound Separation Via Hidden Markov Models,” Proc. Conference on Advances in Neural Information Processing Systems, 2001. That method uses extensive a priori information about the statistical nature of speech from the different speakers, usually represented by dynamic models like a hidden Markov model (HMM), to determine the time-varying filters.

Another method uses multiple microphones to record the simultaneous speech. That method typically requires at least as many microphones as the number of speakers, and the source separation problem is treated as one of blind source separation (BSS). BSS can be performed by independent component analysis (ICA). There, no a priori knowledge of the signals is assumed. Instead, the component signals are estimated as a weighted combination of current and past samples taken from the multiple recordings of the mixed signals. The estimated weights optimize an objective function that measures an independence of the estimated component signals, see Hyväarinen, “Survey on Independent Component Analysis,” Neural Computing Surveys, Vol. 2., pp. 94-128, 1999.

Both methods have drawbacks. The time-varying filter method, with known signal statistics, is based on the single-channel recording of the mixed signals. The amount of information present in the single-channel recording is usually insufficient to do effective speaker separation. The blind source separation method ignores all a priori information about the speakers. Consequently, in many situations, such as when the signals are recorded in a reverberant environment, the method fails.

Therefore, it is desired to provide a method for separating mixed speech signals that improves over the prior art.

### SUMMARY OF THE INVENTION

The method according to the invention uses detailed a prior statistical information about acoustic speech signals, e.g., speech, to be separated. The information is represented in hidden Markov models (HMM). The problem of signal separation is treated as one of beam-forming. In beam-forming, each signal is extracted using an estimated filter-and-sum array.

The estimated filters maximize a likelihood of the filtered and summed output, measured on the HMM for the desired signal. This is done by factorial processing using a factorial HMM (FHMM). The FHMM is a cross-product of the HMMs for the multiple signals. The factorial processing iteratively estimates the best state sequence through the HMM for the signal from the FHMM for all the concurrent signals, using the current output of the array, and estimates the filters to maximize the likelihood of that state sequence.

In a two-source mixture of acoustic signals, the method according to the invention can extract a background acoustic signal that is 20 dB below a foreground acoustic signal when the HMMs for the signals are constructed from the acoustic signals.

### BRIEF DESCRIPTION OF THE DRAWINGS

FIG. 1 is a block diagram of a system for separating mixed acoustic signals according to the invention;

FIG. 2 is a block diagram of a method for separating mixed acoustic signals according to the invention;

FIG. 3 is flow diagram of factorial HMMs used by the invention;

FIG. 4A is a graph of a mixed speech signal to be separated; and

FIGS. 4B-C are graphs of separated speech signals according to the invention.

### DETAILED DESCRIPTION OF THE PREFERRED EMBODIMENT

System Structure

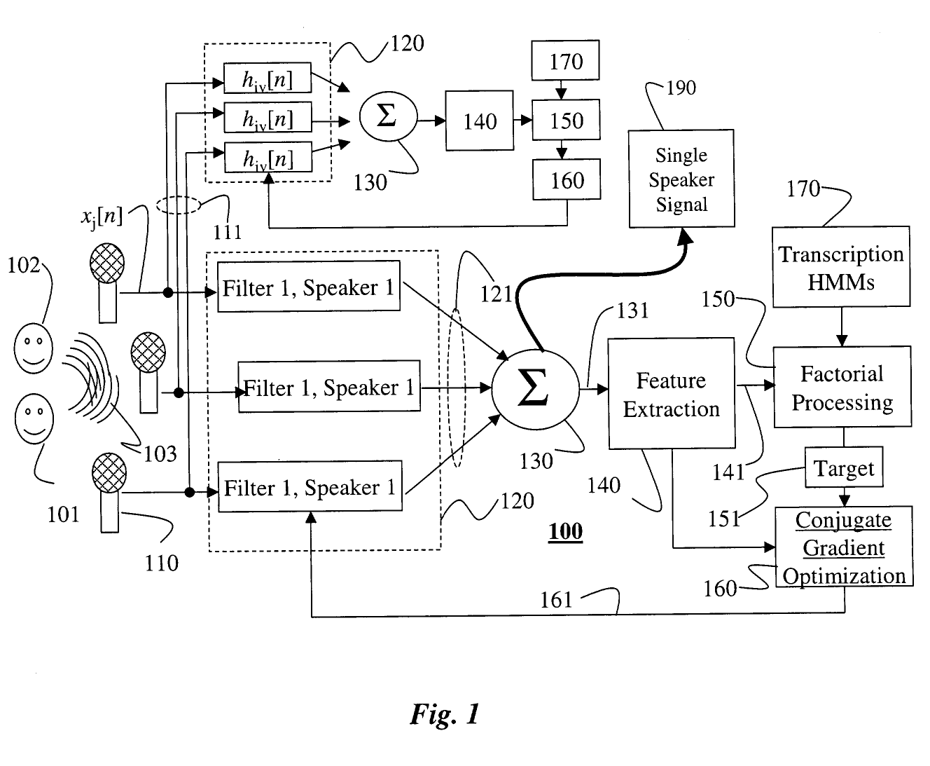

FIG. 1 shows the basic structure of a system 100 for multi-channel acoustic signal separation according to our invention. In this example, there are two sources, e.g., speakers 101-102, generating a mixed acoustic signal, e.g., speech 103. More sources are possible. The object of the invention is to separate the signal 190 of a single source from the acquired mixed signal.

The system includes multiple microphones 110, at least one for each speaker or other source. Connected to the multiple microphones are multiple sets of filter 120. There is one set of filters 120 for each speaker, and the number of filters in each set 120 is equal to the number of microphones 110.

The output 121 each set of filters 120 is connected to a corresponding adder 130, which provides a summed signal 131 to a feature extraction module 140.

Extracted features 141 are fed to a factorial processing module 150 having its output connected to an optimization module 160. The features are also fed directly to the optimization module 160. The output of the optimization module 160 is fed back to the corresponding set of filters 120. Transcription hidden Markov models (HMMs) 170 for each speaker also provide input to the factorial processing module 150. It should be noted that HMMs do not need to be transcription based, e.g., the HMMs can be derived directly from the acoustic content, in whatever form or source, music, machinery sounds, natural sounds, animal sounds, and the like.

System Operation

During operation, the acquired mixed acoustic signals 111 are first filtered 120. An initial set of filter parameters can be used. The filtered signal 121 is summed, and features 141 are extracted 140. A target sequence 151 is estimated 150 using the HMMs 170. An optimization 160, using a conjugate gradient descent, then derives optimal filter parameters 161 that can be used to separate the signal 190 of a single source, for example a speaker.

The structure and operation of the system and method according to our invention is now described in greater detail.

Filter and Sum

We assume that the number of sources is known. For each source, we have a separate filter-and-sum array. The mixed signal 111 from each microphone 110 is filtered 120 by a microphone-specific filter. The various filtered signals 121 are summed 130 to obtain a combined 131 signal. Thus, the combined output signal yᵢ[n] 131 for source i is:

$${y}_{i} [ n ] = {\sum }_{j = 1}^{L} {h}_{i j} [ n ] * {x}_{j} [ n ] \qquad ( 1 )$$

where L is the number of microphones 110, xⱼ[n] is the signal 111 at the j^{th} microphone, and hᵢⱼ[n] is the filter applied to the j^{th} filter for speaker i. The filter impulse responses hᵢⱼ[n] is optimized by optimal filter parameters 161 such that the resultant output yᵢ[n] 190 is the separated signal from the i^{th} source.

Optimizing the Filters for a Source

The filters 120 for the signals from a particular source are optimized using available information about their acoustic signal, e.g., a transcription of the speech from the speaker.

We can use a speaker-independent hidden Markov model (HMM) based speech recognition system that has been trained on a 40-dimensional Mel-spectral representation of the speech signal. The recognition system includes HMMs for the various sound units in the acoustic signal.

From these, and perhaps, the known transcription for the speaker's utterance, we construct the HMM 170 for the utterance. Following this, the parameters 161 for the filters 120 for the speaker are estimated to maximize the likelihood of the sequence of 40-dimensional Mel-spectral vectors determined from the output 141 of the filter-and-sum array, on the utterance HMM 170.

For the purpose of optimization, we express the Mel-spectral vectors as a function of the filter parameters as follows.

First we concatenate the filter parameters for the i^{th} source, for all channels, into a single vector hᵢ. A parameter Zᵢ represent the sequence of Mel-spectral vectors extracted 141 from the output 131 of the array for the i^{th} source. The parameter zᵢₜ is the t^{th} spectral vector in Zᵢ. The parameter zᵢₜ is related to the vector hᵢ by:

zᵢₜ=log (M|DFT(yᵢₜ)|²)=log (M(diag(FXₜhᵢhᵢ^{T}Xₜ^{T}F^{H}))) (2)

where Yᵢₜ is a vector representing the sequence of samples from yᵢ[n] that are used to determine Zᵢₜ, M is a matrix of the weighting coefficients for the Mel filters, F is the Fourier transform matrix, and Xₜ is a super matrix formed by the channel inputs and their shifted versions.

Let Λᵢ represent the set of parameters for the HMM for the i^{th} source. In order to optimize the filters for the i^{th} source, we maximize Lᵢ(Zᵢ)=log (P(Zᵢ|Λᵢ)), the log-likelihood of Zᵢ on the HMM for that source. The parameter Lᵢ(Zᵢ) is determined over all possible state sequences through the HMMs 170.

To simplify the optimization, we assume that the overall likelihood of Zᵢ is largely represented by the likelihood of the most likely state sequence through the HMM, i.e., P(Zᵢ|Λᵢ)=P(Zᵢ, Sᵢ|Λᵢ), where Sᵢ represents the most likely state sequence through the HMM. Under this assumption, we get

$${L}_{i} ( {Z}_{i} ) = {\sum }_{t = 1}^{T} log ( P ( {z}_{i t} \vert {s}_{i t} ) ) + log ( P ( {s}_{i 1} , {s}_{i 2} , … , {s}_{i T} ) ) \qquad ( 3 )$$

where T represents the total number of vectors in Zᵢ, and sᵢⱼ represents the state at time t in the most likely state sequence for the i^{th} source. The second log term in the sum does not depend on zᵢⱼ, or the filter parameters, and therefore does not affect the optimization. Hence, maximizing Equation 3 is the same as maximizing the first log term.

We make the simplifying assumption that this is equivalent to minimizing the distance between Zᵢ and the most likely sequence of vectors for the state sequence Sᵢ.

When state output distributions in the HMM are modeled by a single Gaussian, the most likely sequence of vectors is simply the sequence of means for the states in the most likely state sequence.

Hereinafter, we refer to this sequence of means as a target sequence 151 for the speaker. An objective function to be optimized in the optimization step 160 for the filter parameters 161 is defined by

$${Q}_{i} = {\sum }_{t = 1}^{T} ( {( {z}_{i t} - {m}_{{s}_{i t}}^{i} )}^{T} ( {z}_{i t} - {m}_{{s}_{i t}}^{i} ) ) \qquad ( 4 )$$

where the t^{th} vector in the target sequence mₛ_{ᵢⱼ}^{t} is the mean of sᵢₜ, the t^{th} state, in the most likely state sequence Sᵢ.

Equations 2 and 4 indicate that Qᵢ is a function of hᵢ. However, direct optimization of Qᵢ with respect to hᵢ is not possible due to the highly non-linear relationship between the two. Therefore, we optimize Q using an optimization method such as conjugate gradient descent.

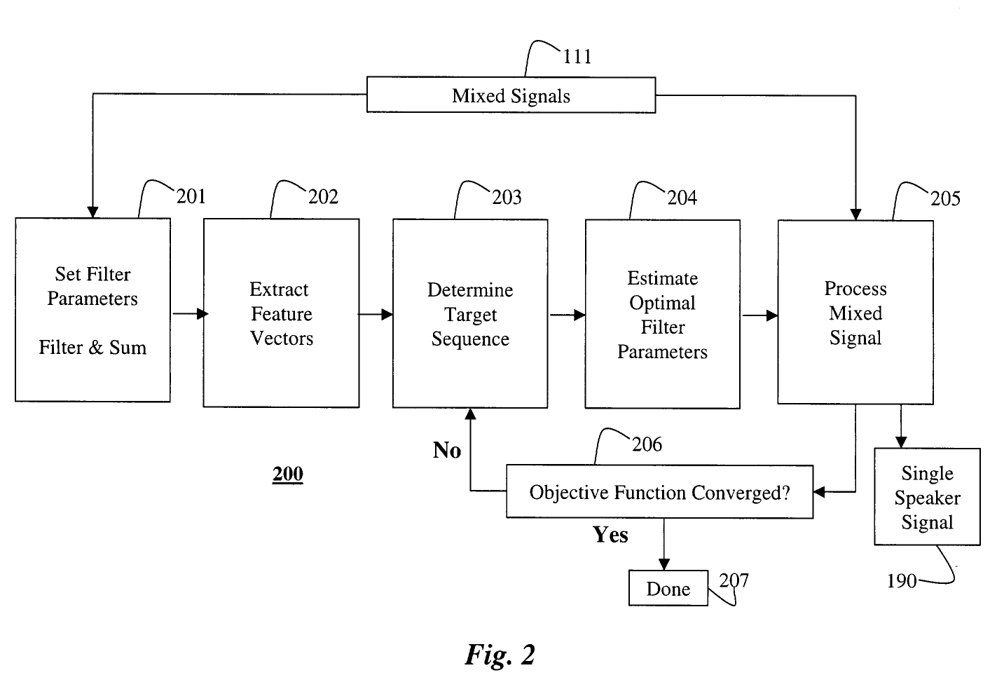

FIG. 2 shows the steps of the method 200 according to the invention.

First, initialize 201 the filter parameters to hᵢ[0]=1/N, and hᵢ[k]=0 for k≠0-. and filter and sum the mixed signals 111 for each speaker using Equation 1.

Second, extract 202 the feature vectors 141.

Third, determine 203 the state sequence, and the corresponding target sequence 151 for an optimization.

Fourth, estimate 204 optimal filter parameters 161 with an optimization method such as conjugate gradient descent to optimize Equation 4.

Fifth, re-filter and sum the signals with the optimized filter parameters. If the new objective function has not converged 206, then repeat the third and fourth step 203, until done 207.

Because the process minimizes a distance between the extracted features 141 and the target sequence 151, the selection a good target is important.

Target Estimation

An ideal target is a sequence of Mel-spectral vectors obtained from clean uncorrupted recordings of the acoustic signals. All other targets are only approximations to the ideal target. To approximate this ideal target, we derive the target 151 from the HMMs 170 for that speaker's utterance. We do this by determining the best state sequence through the HMMs from the current estimate of the source's signal.

A direct approach finds the most likely state sequence for the sequence of Mel-spectral vectors for the signal. Unfortunately, in the initial iterations of the process, before the filters 120 are fully optimized, the output 131 of the filter-and-sum array for any speaker contains a significant fraction of the signal from other speakers as well. As a result, naive alignment of the output to the HMMs results in a poor estimate of the target.

Therefore, we also take into consideration the fact that the array output is a mixture of signals from all the sources. The HMM that represents this signal is a factorial HMM (FHMM) that is a cross-product of the individual HMMs for the various sources. In the FHMM, each state is a composition of one state from the HMMs for each of the sources, reflecting the fact that the individual sources' signal can be in any of their respective states, and the final output is a combination of the output from these states.

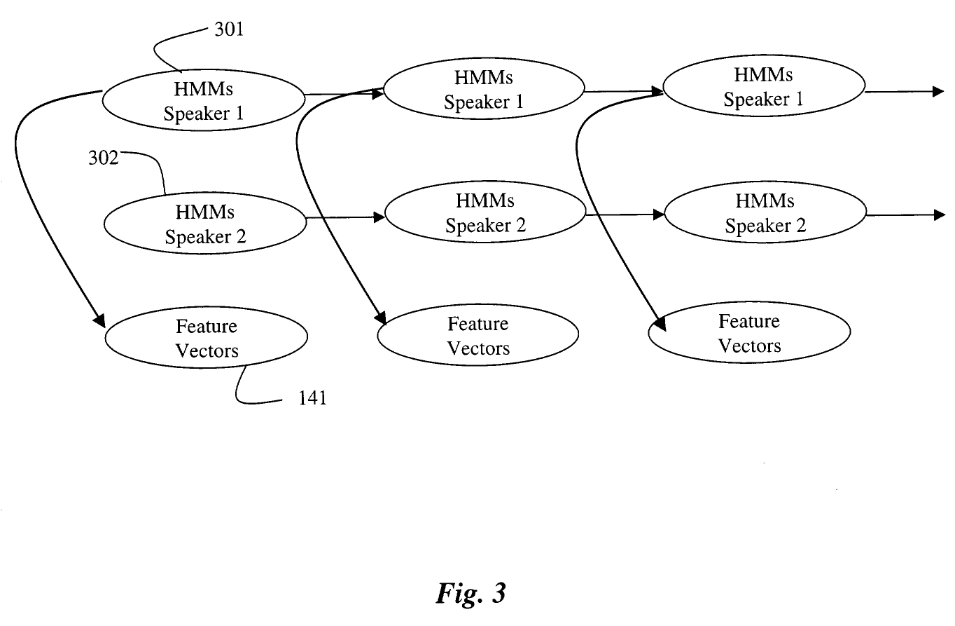

FIG. 3 shows the dynamics of the FHMM for the example of two speakers with two chains of HMMs 301-302, one for each speaker. The HMMs operate with the feature vectors 141

Let Sᵢ^{k} represent the i^{th} state of the HMM for the k^{th} speaker, where kε[1,2]. Sᵢⱼ^{kl} represents the factorial state obtained when the HMM for the k^{th} speaker is in state i, and that for the l^{th} speaker is in state j. The output density of Sᵢⱼ^{kl} is a function of the output densities of its component states

P(x|Sᵢⱼ^{kl})=ƒ(P(X|Sᵢ^{k}), P(X|Sⱼ^{l})) (5)

The precise nature of the function θ( ) depends on the proportions to which the signals 103 from the speakers are mixed in the current estimate of the desired speaker's signal. This in turn depends on several factors including the original signal levels of the various speakers, and the degree of separation of the desired speaker effected by the current set of filters. Because these are difficult to determine in an unsupervised manner, ƒ( ) cannot be precisely determined.

We do not attempt to estimate ƒ( ). Instead, the HMMs for the individual sources are constructed to have simple Gaussian state output densities. We assume that the state output density for any state of the FHMM is also a Gaussian whose mean is a linear combination of the means of the state output densities of the component states.

We define mᵢⱼ^{kl}, the mean of the Gaussian state output density of Sᵢⱼ^{kl} as

mᵢⱼ^{kl}=A^{k}mᵢ^{k}+A^{l}mⱼ^{l} (6)

where mᵢ^{k} represents the D dimensional mean vector for S^{k}, and A^{k} is a D×D weighting matrix.

We consider three options for the covariance of a factorial state Sᵢⱼ^{kl}.

All factorial states have a common diagonal covariance matrix C. i.e. the covariance of any factorial state Sᵢⱼ^{kl} is given by Cᵢⱼ^{kl}=C. The covariance of Sᵢⱼ^{kl} is given by Cᵢⱼ^{kl}=B(Cᵢ^{k}+Cⱼ^{l}) where Cᵢ^{k} is the covariance matrix for Sᵢ^{k}, and B is a diagonal matrix. is given by Cᵢⱼ^{kl}=B^{k}Cⱼ^{l}+B^{l}Cⱼ^{l}, where B^{k} is a diagonal matrix,

B^{k}=diag(b^{k}).

We refer to the first approach as the global covariance approach and the latter two as the composed covariance approaches. The state output density of the factorial state Sᵢⱼ^{kl} is now given by

P(Zₜ|Sᵢⱼ^{kl})=|Cᵢⱼ^{kl}|^{-1/2}(2π)^{-D/2}e^{-1/2(Z}^{ₜ}^{-m}^{ᵢⱼ}^{^{kl}}⁾^{^{t}}^{(C}^{ᵢⱼ}^{^{kl}}⁾^{⁻¹}^{(Z}^{ₜ}^{-m}^{ᵢⱼ}^{^{kl}}⁾ (7)

The various Aₖ values and the covariance parameter values (C, B, or B^{k}, depending on the covariance option considered) values are unknown, and are estimated from the current estimate of the speaker's signal. The estimation is performed using an expectation maximization (EM) process.

In the expectation (E) step of the process, the a posteriori probabilities of the various factorial states, and thereby the a posteriori probabilities of the states of the HMMs for the speakers, are found. The factorial HMM has as many states as the product of the number of states in its component HMMs. Thus, direct computation of the (E) step is prohibitive.

Therefore, we take a variational approach, see Ghahramani et al., “Factorial Hidden Markov Models,” Machine Learning, Vol. 29, pp. 245-275, Kluwer Academic Publishers, Boston 1997. In the maximization (M) step of the process, the computed a posteriori probabilities are used to estimate the A^{k} as

$$A = {\sum }_{i = 1}^{{N}_{k}} {\sum }_{j = 1}^{{N}_{l}} {\sum }_{t} ( {Z}_{t} {{P}_{i j} ( t )}^{′} {M}^{′} ) {( M {\sum }_{t} ( {P}_{i j} ( t ) {{P}_{i j} ( t )}^{′} ) {M}^{′} )}^{- 1} \qquad ( 8 )$$

where A is a matrix composed by A¹ and A² as A=[A¹, A²], Pᵢⱼ (ₜ) is a vector whose i^{th} and (N^{k}+j)^{th} values equal P(Zᵢ|Sᵢ^{k}) and P(Zᵢ|Sⱼ^{l}), and M is a block matrix in which blocks are formed by matrices composed by the means of the individual state output distributions.

For the composed variance approach where Cᵢⱼ^{kl}=B^{k}Cᵢ^{k}+B^{l}Cⱼ^{l}, the diagonal component b^{k} of the matrix B^{k} is estimated in the n^{th} iteration of the EM algorithm as

$${b}_{n}^{k} = {\sum }_{t , i , j = 1}^{T , {N}_{k} , {N}_{l}} {( {Z}_{t} - {m}_{i j}^{k l} )}^{′} {( I + {( {B}_{n - 1}^{k} {C}_{i}^{k} )}^{- 1} {B}_{n - 1}^{l} {C}_{j}^{l} )}^{- 1} ( {Z}_{t} - {m}_{i j}^{k l} ) {p}_{i j} ( t ) \qquad ( 9 )$$

where pᵢⱼ (t)=P(Zᵢ|Sᵢⱼ^{kl}).

The common covariance C for the global covariance approach, and B for the first composed covariance approach can be similarly computed.

After the EM process converges and the AₖS, the covariance parameters (C, B, or B^{k}, as appropriate) are determined, the best state sequence for the desired speaker can also be obtained from the FHMM, also using the variational approximation.

The overall system to determine the target sequence 151 for a source works as follows. Using the feature vectors 141 from the unprocessed signal and the HMMs found using the transcriptions, parameters A and the covariance parameters (C, B, or B^{k}, as appropriate) are iteratively updated using Equations 8 and 9, until the total log-likelihood converges.

Thereafter, the most likely state sequence through the desired speaker's HMM is found. After the target 151 is obtained, the filters 120 are optimized, and the output 131 of the filter-and-sum array is used to re-estimate the target. The system converges when the target does not change on successive iterations. The final set of filters obtained is used to separate the source's acoustic signal.

Effect of the Invention

The invention provides a novel multi-channel speaker separation system and method that utilizes known statistical characteristics of the acoustic signals from the speakers to separate them.

With the example system for two speakers, the system and method according to the invention improves the signal separation ratios (SSR) by 20 dB over simple delay-and-sum of the prior art. For the case where the signal levels of the speakers are different, the results are more dramatic, i.e., an improvement of 38 dB.

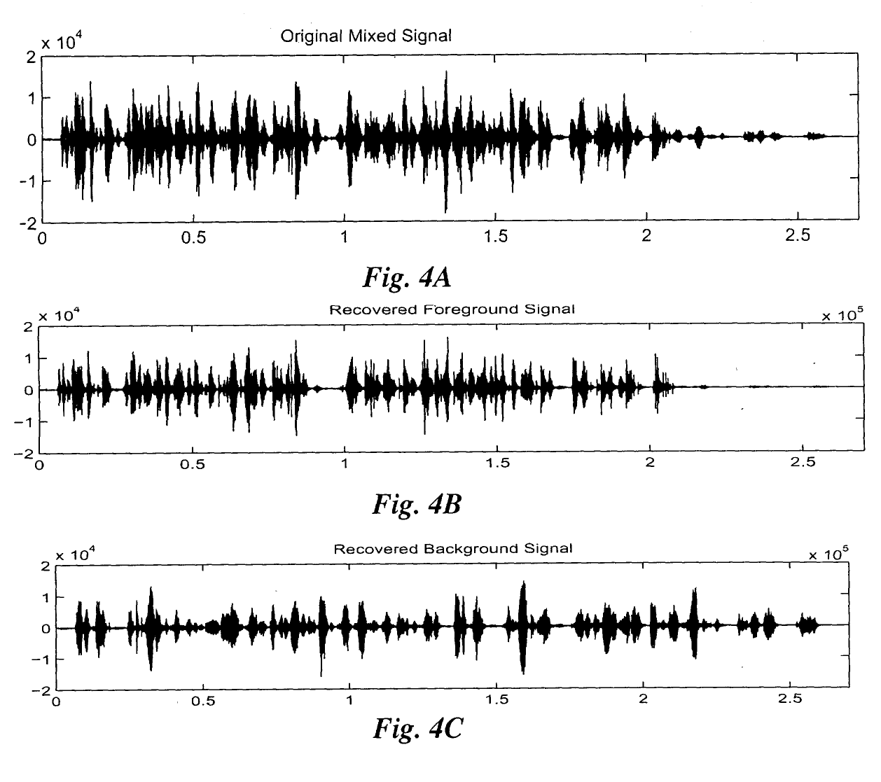

FIG. 4A shows a mixed signal, and FIGS. 4B and 4C show two separated signals obtained by the method according to the invention. The signal separation obtained with the FHMM-based methods is comparable to that obtained with ideal-targets for the filter optimization. The composed-variance FHMM method converges to the final filters in fewer iterations than the method that uses a global covariance for all FHMM states.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for separating a plurality of acoustic signals generated by a plurality of acoustic sources, the plurality of acoustic signals combined in a mixed signal acquired by a plurality of microphones, comprising for each acoustic source:
filtering the mixed signal into filtered signals;
summing the filtered signals into a combined signal;
extracting features from the combined signal;
estimating a target sequence in the combined signal based on the extracted features;
optimizing filter parameters for the target sequence;
repeating the estimating and optimizing steps until the filter parameters converge to optimal filtering parameters; and
filtering the mixed signal once more with the optimal filter parameters, and summing the optimally filtered mixed signals to obtain the acoustic signal for the acoustic source.

2. The method of claim 1 wherein the acoustic source is a speaker and the acoustic signal is speech.

3. The method of claim 1 wherein there is at least one microphone for each acoustic source, and one set of filters for each microphone, and the number of filters in each set is equal to the number of acoustic sources.

4. The method of claim 1 wherein the filter parameters are optimized by gradient descent.

5. The method of claim 1 wherein the target sequences is estimated from hidden Markov models.

6. The method of claim 5 wherein the target sequence is a sequence of means for states in a most likely state sequence of the hidden Markov models.

7. The method of claim 5 wherein the hidden Markov models are independent of the acoustic source.

8. The method of claim 5 wherein the acoustic signal is speech, and the hidden Markov model is based on a transcription the speech.

9. The method of claim 5 further comprising:
representing the mixed signal by a factoral hidden Markov model that is a cross-product of individual hidden Markov models of all of the acoustic signals.

10. A system for separating a plurality of acoustic signals generated by a plurality of acoustic sources, the plurality of acoustic signals combined in a mixed signal acquired by a plurality of microphones, comprising for each acoustic source:
a plurality of filters for filtering the mixed signal into filtered signals;
an adder for summing the filtered signals into a combined signal;
means for extracting features from the combined signal;
means for estimating a target sequence in the combined signal using the extracted features;
means for optimizing filter parameters for the target sequence; and
means for repeating the estimating and optimizing until the filter parameters converge to optimal filtering parameters, and then filtering the mixed signal with the optimal filter parameters, and summing the optimally filtered mixed signals to obtain the acoustic signal for the acoustic source.
